(19) United States
(12) Patent Application Publication
(10) Pub. No.: US 2017/0293190 A1
(43) Pub. Date: Oct. 12, 2017

(54) DISPLAY SUBSTRATE AND METHOD OF MANUFACTURING THE SAME

(71) Applicant: Samsung Display Co., Ltd, Yongin-si (KR)

(72) Inventors: Duk Sung KIM, Asan-si (KR); Hyuk Jin KIM, Asan-si (KR); Ik Han OH, Cheonan-si (KR); Young Min JUNG, Gwangmyeong-si (KR)

(21) Appl. No.: 15/459,285

(22) Filed: Mar. 15, 2017

(30) Foreign Application Priority Data
Apr. 8, 2016 (KR) 10-2016-0043240

(51) Int. Cl. G02F 1/1362; G02F 1/1333; G02F 1/1368

(52) U.S. Cl. CPC G02F 1/136227; G02F 1/1368; G02F 1/133345; G02F 1/136286; G02F 2001/136222; G02F 2201/123

(57) ABSTRACT

A liquid-crystal display device is provided. The liquid-crystal display device comprises a first substrate, a thin-film transistor disposed on the first substrate, a color filter layer disposed on the thin-film transistor, a photosensitive layer disposed on the color filter layer, and a pixel electrode disposed on the photosensitive layer and connected to the thin-film transistor via a contact hole penetrating the photosensitive layer. The photosensitive layer comprises a first area overlapping the thin-film transistor, a second area overlapping the contact hole, and a third area that is the rest of the photosensitive layer except the first and second areas. The photosensitive layer has a first thickness in the first area, is opened in a center of the second area, and has a second thickness in the third area, wherein the second thickness is smaller than the first thickness.

This application claims priority from Korean Patent Application No. 10-2016-0043240 filed on Apr. 8, 2016 in the Korean Intellectual Property Office, the disclosure of which is incorporated herein by reference in its entirety.

### BACKGROUND

### 1. Field of the Disclosure

The present disclosure relates to a display substrate, and a method of manufacturing a display substrate.

### 2. Description of the Related Art

A liquid-crystal display (LCD) device includes a first display substrate including a plurality of pixel electrodes arranged thereon in a matrix, a second display substrate facing the first display substrate, and a liquid-crystal layer disposed between the first display substrate and the second display substrate. The first display substrate may include a plurality of signal lines supplying electric signals to the pixel electrodes, and switching elements.

To form a variety of elements disposed on the first display substrate and the second display substrate, it is necessary to perform mask processes repeatedly. Unfortunately, as the number of times of repeating mask processes increases, the manufacturing cost of the display device increases. Accordingly, what is required is an approach to reduce the number of times that the mask processes are performed.

### SUMMARY

Aspects of the present disclosure provide a display substrate with reduced manufacturing cost.

Aspects of the present disclosure also provide a method of manufacturing a display substrate with reduced manufacturing cost.

These and other aspects, embodiments and features of the present disclosure will become immediately apparent to those of ordinary skill in the art upon review of the Detailed Description and Claims to follow.

According to an exemplary embodiment of the present disclosure, there is provided a liquid-crystal display device. The liquid-crystal display device comprises a first substrate, a thin-film transistor disposed on the first substrate, a color filter layer disposed on the thin-film transistor, a photosensitive layer disposed on the color filter layer, and a pixel electrode disposed on the photosensitive layer and connected to the thin-film transistor via a contact hole penetrating the photosensitive layer. The photosensitive layer comprises a first area overlapping the thin-film transistor, a second area overlapping the contact hole, and a third area that is the rest of the photosensitive layer except the first and second areas. The photosensitive layer has a first thickness in the first area, is opened in a center of the second area, and has a second thickness in the third area, wherein the second thickness is smaller than the first thickness.

According to another exemplary embodiment of the present disclosure, there is provided a liquid-crystal display device. The liquid-crystal display device comprises a first substrate, a thin-film transistor disposed on the first substrate, a color filter layer disposed on the thin-film transistor, first and second photosensitive composition patterns disposed on the color filter layer, and a pixel electrode disposed on the second photosensitive composition pattern and connected to the thin-film transistor via a contact hole penetrating the color filter layer. A part of a side wall of the contact hole is covered by the second photosensitive composition pattern, and the first and second photosensitive composition patterns are made of a same material.

According to an exemplary embodiment of the present disclosure, there is provided a method of manufacturing a liquid-crystal display device. The method of manufacturing the liquid-crystal display device comprises forming a thin-film transistor on a substrate, forming an organic layer disposed on the thin-film transistor, forming a photosensitive layer on the organic layer, and forming a pixel electrode on the photosensitive layer. The forming the photosensitive layer comprises (a) forming a photosensitive composition layer by applying a photosensitive composition on the organic layer, (b) performing exposure and development so that the photosensitive composition layer has different thicknesses in different areas, and (c) etching the photosensitive composition layer to expose an output terminal of the thin-film transistor.

According to exemplary embodiments of the present disclosure, there is provided a display substrate with reduced manufacturing cost.

In addition, according to exemplary embodiments of the present disclosure, there is provided a method of manufacturing a display substrate with reduced manufacturing cost.

It should be noted that features of the present disclosure are not limited to those described above and other features of the present disclosure will be apparent to those skilled in the art from the following descriptions.

### BRIEF DESCRIPTION OF THE DRAWINGS

The above and other features of the present disclosure will become more apparent by describing in detail exemplary embodiments thereof with reference to the attached drawings, in which:

FIG. 1 is a layout diagram of a display device according to an exemplary embodiment of the present disclosure;

FIG. 2 is a cross-sectional view taken along line I-I′ of FIG. 1;

FIG. 3 is a diagram showing a layout of a data line, a gate line, a thin-film transistor, a contact hole and a photosensitive layer in the display device shown in FIG. 1;

FIGS. 4, 5, 6, and 7 are cross-sectional views showing processing operations of a method of manufacturing the display device shown in FIG. 1;

FIG. 8 is a cross-sectional view of a display device according to another exemplary embodiment of the present disclosure; and

FIGS. 9 and 10 are cross-sectional views showing processing operations of a method of manufacturing the display device shown in FIG. 8.

### DETAILED DESCRIPTION OF THE EMBODIMENTS

The inventive concept will now be described more fully hereinafter with reference to the accompanying drawings, in which embodiments are shown. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art. The same reference numbers indicate the same components throughout the specification. In the attached figures, the thickness of layers and regions is exaggerated for clarity.

It will be understood that, although the terms first, second, third, etc., may be used herein to describe various elements, these elements should not be limited by these terms. These terms are only used to distinguish one element from another element. Thus, a first element discussed below could be termed a second element without departing from the teachings of the inventive concept.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

In the embodiments, an electronic apparatus may be any apparatus provided with a display device. Examples of the electronic apparatus may include smart phones, mobile phones, navigators, game machines, TVs, car head units, notebook computers, laptop computers, tablet computers, personal media players (PMPs), and personal digital assistants (PDAs). The electronic apparatus may be embodied as a pocket-sized portable communication terminal having a wireless communication function. Further, the display device may be a flexible display device capable of changing its shape.
Hereinafter, embodiments will be described with reference to the accompanying drawings.

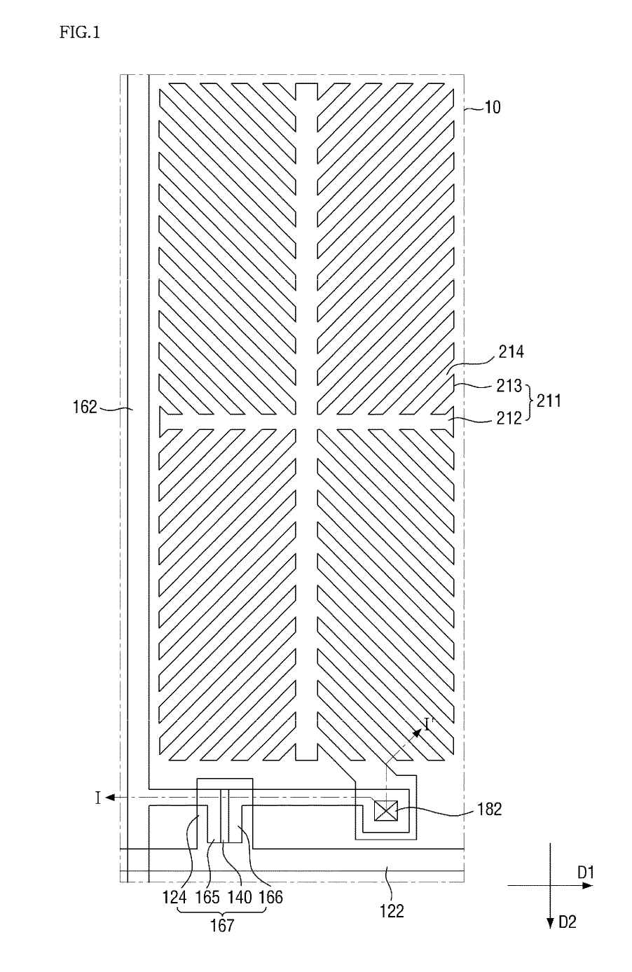

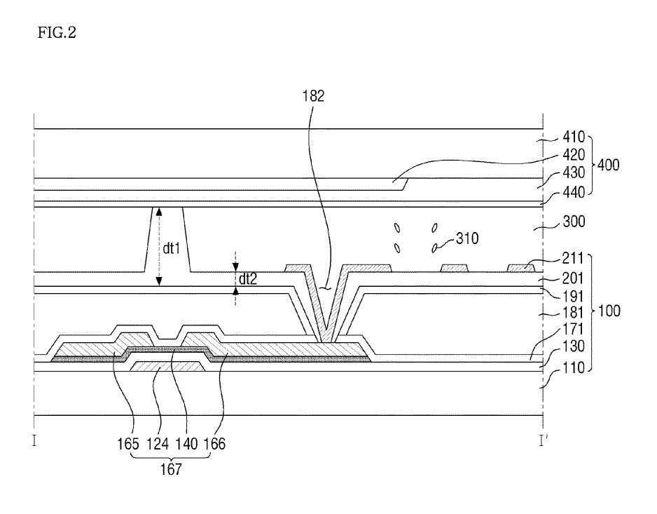

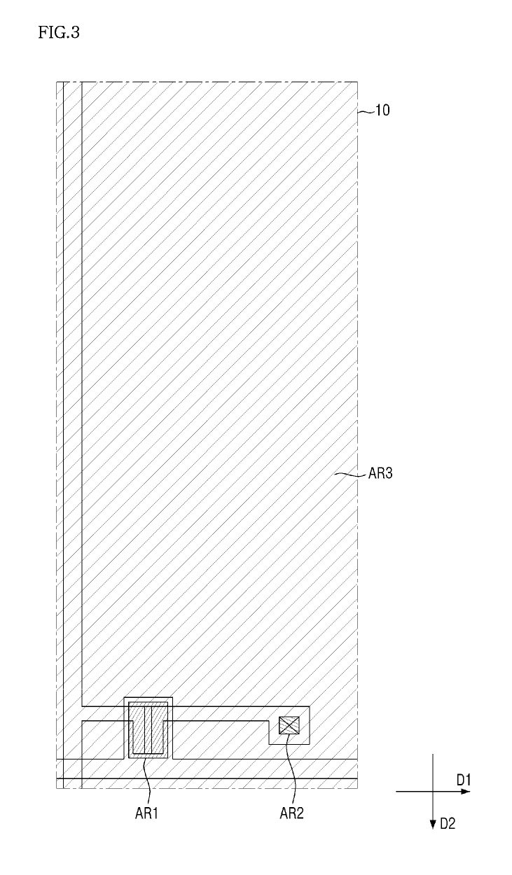

FIG. 1 is a layout diagram of a single pixel disposed in an LCD device according to an exemplary embodiment of the present disclosure. FIG. 2 is a cross-sectional view taken along line I-I′ of FIG. 1. FIG. 3 is a plan view showing an example layout of a data line, a gate line, a thin-film transistor, a contact hole and a photosensitive layer in the pixel of the LCD device shown in FIG. 1.

Referring to FIGS. 1 to 3, the LCD device according to the exemplary embodiment of the present disclosure includes a first display substrate 100, a second display substrate 400 and a liquid-crystal layer 300.

The LCD device includes a plurality of pixels 10 arranged in a matrix. Each of the plurality of pixels 10 may be a basic unit for producing a color at a particular grayscale. The first display substrate 100 includes pixel electrodes 211 each disposed in the respective pixels 10, and thin-film transistors 167 each being a switching element for applying a data voltage to the respective pixel electrodes 211. The second display substrate 400 is disposed such that it faces the first display substrate 100. The liquid-crystal layer 300 is a space between the first display substrate 100 and the second display substrate 400 where liquid crystals 310 are injected.

Hereinafter, the first display substrate 100 will be described.

The first display substrate 100 includes a first base substrate 110. The first base substrate 110 may be a transparent insulation substrate. For example, the first base substrate 110 may be a glass substrate, a quartz substrate, a transparent resin substrate, etc. Although the first base substrate 110 is a flat substrate, it may be curved in a direction.

A plurality of gate lines 122 and gate electrodes 124 are disposed on the first base substrate 110.

The gate line 122 delivers a gate signal for controlling the thin-film transistor 167. The gate line 122 may be extended in a first direction D1. As used herein, the first direction D1 refers to a direction extending in parallel with a side of the first base substrate 110. As shown in FIG. 2, the first direction D1 may be defined as a direction indicated by a straight line extending from the left side to the right side. However, the first direction D1 is not limited to being in parallel with a side of the first base substrate 110. The first direction D1 may be a direction indicated by any straight line extending in a certain direction on the first base substrate 110.

The gate signal may be a signal having a variable voltage value supplied from an external device. The thin-film transistor 167 may be turned on/off in response to the voltage value of the gate signal.

The gate electrode 124 is connected to the gate line 122. The gate electrode 124 may have a shape protruding from the gate line 122. The gate electrode 124 may work as a control electrode of the thin-film transistor 167. One gate line 122 may be connected to a plurality of gate electrodes 124.

The gate lines 122 and the gate electrodes 124 may include: an aluminum-based metal such as aluminum (Al) and an aluminum alloy; a silver-based metal such as silver (Ag) and a silver alloy; a copper-based metal such as copper (Cu) and a copper alloy; a molybdenum-based metal such as molybdenum (Mo) and a molybdenum alloy; chrome (Cr); tantalum (Ta); and titanium (Ti).

The gate lines 122 and the gate electrodes 124 may have a single layer structure. Alternatively, the gate lines 122 and the gate electrodes 124 may have a multi-layer structure including at least two conductive films having different physical properties.

A gate insulation film 130 is disposed on the gate line 122 and the gate electrode 124. The gate insulation film 130 may be made of an insulative material, for example, silicon nitride or silicon oxide. The gate insulation film 130 may have a single layer structure or may have multi-layer structure including two insulation layers having different physical properties.

A semiconductor layer 140 is disposed on the gate insulation layer 130. The semiconductor layer 140 may overlap at least a part of the gate electrode 124. The semiconductor layer 140 may be made of amorphous silicon, polycrystalline silicon or oxide semiconductor.

The semiconductor layer 140 may overlap at least a part of or the entirety of a data line 162, a source electrode 165 and a drain electrode 166 depending on processing operations, as well as the gate electrode 124.

Although not shown in the drawings, in some embodiments, an ohmic contact element may be additionally disposed on the semiconductor layer 140. The ohmic contact element may be made of n+ hydrogenated amorphous silicon that is highly doped with n-type impurities, or may be made of silicide. A pair of the ohmic contact elements may be disposed on the semiconductor layer 140. The ohmic contact elements may be disposed between the source electrode 165 and the semiconductor layer 140 and between the drain electrode 166 and semiconductor layer 140, so that they have ohmic contact property.

On the semiconductor layer 140 and the gate insulation film 130, a plurality of data lines 162, the source electrode 165 and the drain electrode 166 are disposed.

The data lines 162 may be extended in a second direction D2 to intersect the gate lines 122.

Herein, the second direction D2 may be a direction intersecting the first direction D1 at the right angle on the plane. As shown in FIG. 1, the second direction D2 may be a direction indicated by a straight line extending from the upper side to the lower side. However, this is merely illustrative. The angle made by the second direction D2 and the first direction D1 may not be the right angle. In that case, the second direction D2 may be a direction indicated by a straight line extending not in parallel with the first direction D1.

The data lines 162 may be insulated from the gate lines 122 and the gate electrodes 124 by the gate insulation film 130.

The data line 162 may provide a data signal to the source electrode 165. The data signal may have a varying voltage value provided from an external source, and the gray scale of each of the pixels 10 may be controlled in response to the data signal.

The source electrode 165 may branch off from the data line 162 and may overlap at least a part of the gate electrode 124.

The drain electrode 166 may be spaced apart from the source electrode 165 on the plane with the semiconductor layer 140 therebetween, and may overlap at least a part of the gate electrode 124. As shown in FIG. 1, the source electrode 165 is extended in a straight line and may be in parallel with the drain electrode 166 and spaced apart from it by a predetermined distance. However, this is merely illustrative. For example, the source electrode 165 may have a “U”-shape such that it surrounds the drain electrode 166 with a predetermined gap therebetween.

In addition, the semiconductor layer 140 may be disposed also in an area between the source electrode 165 and the drain electrode 166 that are spaced apart from each other. That is, the source electrode 165 and the drain electrode 166 may partially overlap or come in contact with the semiconductor layer 140 and may face each other with the semiconductor layer 140 therebetween.

The data lines 162, the source electrodes 165 and the drain electrodes 166 may be made of silver-aluminum, copper, silver, molybdenum, chrome, titanium, tantalum or an alloy thereof. In addition, they may have, but are not limited to, a multi-layer structure composed of a lower layer (not shown) such as a refractory metal and a low-resistance upper layer (not shown) formed on the lower layer.

The gate electrode 124, the semiconductor layer 140, the source electrode 165 and the drain electrode 166 form the thin-film transistor 167. The thin-film transistor 167 may electrically connect the source electrode 165 to the drain electrode 166 in response to a voltage value of the gate signal supplied to the gate electrode 124. Specifically, if the voltage value of the gate signal supplied to the gate electrode 124 reaches the voltage value to turn off the thin-film transistor 167, the source electrode 165 and the drain electrode 166 may be electrically insulated from each other. On the other hand, if the voltage value of the gate signal supplied to the gate electrode 124 reaches the voltage value to turn on the thin-film transistor 167, the source electrode 165 and the drain electrode 166 may be electrically connected to each other via a channel formed in the semiconductor layer 140 between the source electrode 165 and the drain electrode 166.

The channel may be formed in the semiconductor layer 140 between the source electrode 165 and the drain electrode 166. Specifically, when the thin-film transistor 167 is turned on, the channel is formed in the semiconductor layer 140 between the source electrode 165 and the drain electrode 166. The voltage may be delivered from the source electrode 165 to the drain electrode 166 via the channel. The data signal delivered to the drain electrode 166 is delivered to the pixel electrode 211 connected thereto.

A first passivation layer 171 is disposed on the gate insulation layer 130 and the thin-film transistor 167. The first passivation layer 171 may be made of an inorganic insulative material such as silicon oxide, silicon nitride and silicon oxynitride, and may cover the thin-film transistor 167. The first passivation layer 171 may protect the thin-film transistor 167 from other elements disposed on the thin-film transistor 167.

A color filter layer 181 is disposed on the first passivation layer 171. The color filter layer 181 may allow light incident on the first base substrate 110 to have a particular color.

The color filter layer 181 may be made of a photosensitive organic composition containing a pigment for reproducing a color and may include one of red, green or blue pigments.

In addition, the color filter layer 181 may include first, second, and third color filters. The first to third color filters may allow the light transmitting the color filter layer 181 to have red, green and blue colors and may be made of red, green and blue pigments.

The first to third color filters may be patterned by using different masks, respectively. Accordingly, each of the color filters may be formed in the respective pixels 10. In each of the pixels 10, the color filter may have a depressed portion that is partially dented from the flat top surface of the color filter layer 181. The depressed portion of the color filter layer 181 may overlap a part of the drain electrode 166 and may form a contact hole 182.

A second passivation layer 191 is disposed on the color filter layer 181. The second passivation layer 191 may be made of an inorganic insulation material such as silicon oxide, silicon nitride, silicon oxynitride, etc. The second passivation layer 191 may prevent the color filter layer 181 from being peeled off and may suppress the liquid-crystal layer 300 from being contaminated by organic material such as a solvent introduced from the color filter layer 181. By doing so, it is possible to prevent defects such as afterimage possibly occurring when the LCD device is driven.

A photosensitive layer 201 is disposed on the second passivation layer 191. The photosensitive layer 201 may be made of a photosensitive resin composition. When the photosensitive resin composition is exposed to light of a certain wavelength, polymerization reaction or decomposition reaction takes place. In addition, the photosensitive resin composition may have a high transmittance and may have transparency if it is made sufficiently thin.

The photosensitive layer 201 may include a first area AR1 overlapping the thin-film transistor 167, a second area AR2 overlapping the contact hole 182, and a third area AR3 that is the rest of the photosensitive layer 201 except the first and second areas AR1 and AR2, as shown in FIG. 3. In particular, the first area AR1 may overlap the gate electrode 124.

The photosensitive layer 201 may have a first thickness dt1 in the first area AR1, may have an opening in the center of the second area AR2, and may have a second thickness dt2 smaller than the first thickness dt1 in the third area AR3.

As the photosensitive layer 201 has different thicknesses in different areas, the second display substrate 400 may be spaced apart from the first display substrate 100 by a certain gap, and the liquid-crystal layer 300 may be disposed therebetween. That is, the photosensitive layer 201 may work as a spacer in the first area AR1. Accordingly, the photosensitive layer 201 may be in contact with the second display substrate 400 in the first area AR1, such that the first display substrate 100 and the second display substrate 400 are spaced apart from each other by the first thickness dt1 to thereby maintain a cell gap. Liquid crystals 300 may be injected between the first display substrate 100 and the second display substrate 400 spaced apart from each other by the first area AR1 of the photosensitive layer 201, thereby forming the liquid-crystal layer 300.

In addition, the photosensitive layer 201 may be opened in the center of the second area AR2. As described above, the second area AR2 may overlap the contact hole 182. The contact hole 182 mechanically connects the drain electrode 166 disposed thereunder with the pixel electrode 211 disposed thereon. The second passivation layer 191 and the photosensitive layer 201 are disposed between the drain electrode 166 and the pixel electrode 211. Accordingly, in order to mechanically connect the drain electrode 166 with the pixel electrode 211, the photosensitive layer 201 may be opened in the center of the second area AR2, and the second passivation layer 191 may also be opened in the center of the second area AR2.

Side walls of the contact hole 182 may be covered by the second passivation layer 191 and the photosensitive layer 201. Specifically, the second passivation layer 191 covers the side walls of the depression portion of the color filter layer 181 to thereby suppress a solvent or the like from being introduced from the color filter layer 181. In addition, the photosensitive layer 201 covers the second passivation layer 191, to further suppress a solvent or the like from being introduced from the color filter layer 181.

Further, the photosensitive layer 201, which is an essential element during the processing of forming the opening in the second passivation layer 191, may also serve to maintain the gap between the first display substrate 100 and the second display substrate 400, such that the manufacturing cost of the LCD device can be saved. A detailed description thereon will be made below.

The pixel electrode 211 is disposed on the photosensitive layer 201. The pixel electrode 211 may be mechanically connected to the drain electrode 166 via (through) the contact hole 182 and may receive a voltage from the drain electrode 166. In particular, in the area where the contact hole 182 is formed, the pixel electrode 211 may cover the photosensitive layer 201 that covers the side walls of the contact hole 182.

The pixel electrode 211 may include stems 212 and branches 213 protruding radially and extended from the stems 212 and is typically disposed in an active area (not shown).

In the active area, the incident light from below the first display substrate 100 transmits through the second display substrate 400 upwardly. The LCD device may control the polarization and wavelength of the light transmitting in the active area and accordingly the pixels 10 may represent colors.

The stems 212 may have a variety of shapes. For example, the stems 212 may have a cross shape as shown in FIG. 1. In this example, the active area may be divided into four domains by the stems 212.

The branches 213 are formed in each of the domains and may be extended in different directions in different domains. The branches 213 are extended in parallel with and spaced apart from one another in the respective domains, which are divided by the stems 212. Adjacent branches 213 may be spaced apart from one another by a distance in micrometers to thereby form a fine slit 214.

The pixel electrode 211 may be made of a transparent conductive material such as indium tin oxide (ITO), indium zinc oxide (IZO), indium tin zinc oxide (ITZO), Al-doped zinc oxide (AZO).

Although not shown in the drawings, a first alignment layer may be disposed on the pixel electrode 211. The first alignment layer may control an initial orientation angle of the liquid crystals 310 injected into the liquid-crystal layer 300. The first alignment layer may be eliminated.

Next, the second display substrate 400 will be described.

The second display substrate 400 may include a second base substrate 410, a light-blocking element 420, an overcoat layer 430, and a common electrode 440.

The second base substrate 410 may be disposed such that it faces the first base substrate 110. The second base substrate 410 may have durability so that it can withstand external impact. The second base substrate 410 may be a transparent insulation substrate. For example, the second base substrate 410 may be a glass substrate, a quartz substrate, a transparent resin substrate, etc. The second base substrate 410 may be a flat plate, although it may be curved in a particular direction.

The light-blocking element 420 is disposed on (under in FIG. 2) the second base substrate 410. The light-blocking element 420 may be disposed such that it overlaps the gate line 122, the data line 162, the thin-film transistor 167 and the contact hole 182, i.e., it overlaps the other areas than the active area, thereby blocking light transmission in the other area than the active area.

The overcoat layer 430 is disposed on (under in FIG. 2) the second base substrate 410 and the light-blocking element 420. The overcoat layer 430 may reduce a level difference caused by the light-blocking element 420. In some embodiments, the overcoat layer 430 may be eliminated.

The common electrode 440 is disposed on (under in FIG. 2) the overcoat layer 430. The common electrode 440 may be made of a transparent conductive material such as indium tin oxide (ITO), indium zinc oxide (IZO), indium tin zinc oxide (ITZO) and Al-doped zinc oxide (AZO). The common electrode 440 may be formed throughout the entire surface of the second base substrate 410. The common electrode 440 may receive a common signal from an external source and may generate an electric field together with the pixel electrode 211.

Although not shown in the drawings, a second alignment layer may be additionally disposed on (under in FIG. 2) the common electrode 440. The second alignment layer may perform the functions similar to the above-described first alignment layer. That is, the second alignment layer may control the initial orientation of the liquid crystals 310 injected into the liquid-crystal layer 300.

The liquid-crystal layer 300 may include the plurality of liquid crystals 310 having dielectric anisotropy and refractive anisotropy. The liquid crystals 310 may be orientated vertically or horizontally between the first display substrate 100 and the second display substrate 400. When the electric field is applied across the first display substrate 100 and the second display substrate 400, the liquid crystals 310 may be rotated or tilted in a particular direction between the first display substrate 100 and the second display substrate 400 to thereby change the polarization of light.

Hereinafter, a method of manufacturing an LCD device according to an exemplary embodiment of the present disclosure will be described.

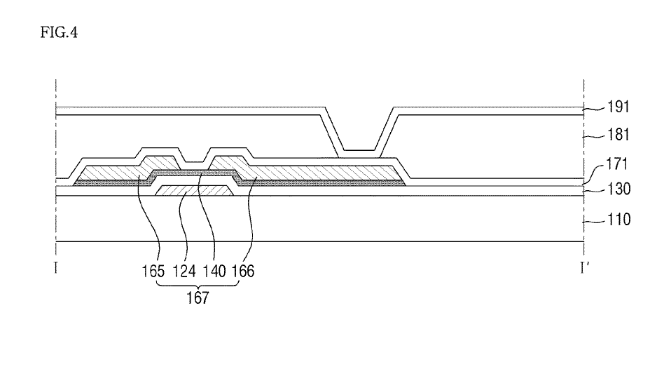

FIGS. 4 to 7 are views for illustrating processing operations of a method of manufacturing a LCD device according to an exemplary embodiment of the present disclosure. FIGS. 4 to 7 are cross-sectional views taken along line I-I′ of FIG. 1.

FIG. 4 shows a processing operation where a second passivation layer 191 is formed after first to fifth mask processes are performed on the first base substrate 110.

The processing operation is described in more detail with reference to FIG. 4. Initially, the first base substrate 110 is prepared.

Subsequently, a gate line 122 and a gate electrode 124 are formed on the first base substrate 110. The gate line 122 and the gate electrode 124 are formed via the first mask process. As used herein, a mask process refers to a patterning process using a photo mask. A single mask process includes an exposure process and a development process and may further include an etch process.

Subsequently, a gate insulation film 130 is formed. The gate insulation layer 130 may be made of silicon nitride or silicon oxide or a stack thereof, and may be formed by chemical vapor deposition or sputtering.

Subsequently, a semiconductor layer 140, a data line 162, a source electrode 165 and a drain electrode 166 are formed. The semiconductor layer 140, the data line 162, the source electrode 165 and the drain electrode 166 are formed via the second mask process. Unlike the first mask process, the second mask process may be carried out by irradiating different amounts of light onto different areas during the exposure process by using a halftone mask. That is, different amounts of light may be irradiated among the area where the semiconductor layer 140 is disposed, the area where the data line 162, the source electrode 165 and the drain electrode 166 are disposed, and the area where none of the elements are disposed.

Subsequently, a first passivation layer 171 is formed. The first passivation layer 171 may be made of an inorganic insulative material such as silicon oxide, silicon nitride and silicon oxynitride, and may be formed by chemical vapor deposition or sputtering.

Subsequently, a color filter layer 181 is formed. The color filter layer 181 may include first to third color filters, which may be formed via different mask processes. That is, the first color filter may be formed via the third mask process, the second color filter may be formed via the fourth mask process, and the third color filter may be formed via the fifth mask process.

Subsequently, a second passivation layer 191 is formed. The second passivation layer 191 may be made of an inorganic insulative material such as silicon oxide, silicon nitride and silicon oxynitride, and may be formed by chemical vapor deposition or sputtering.

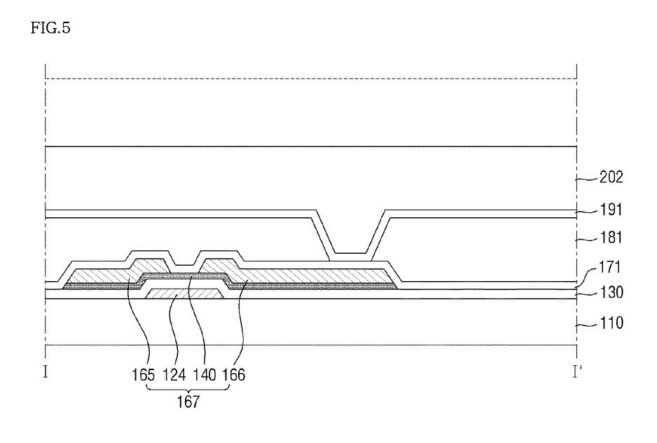

Subsequently, a photosensitive layer 201 and a contact hole 182 are formed. This will be described in more detail below with reference to FIGS. 5 to 7.

In order to form the photosensitive layer 201 and the contact hole 182, a photosensitive resin composition layer 202 is formed on the second passivation layer 191, as shown in FIG. 5. As mentioned earlier, when the photosensitive resin composition of the photosensitive resin composition layer 202 is exposed to light of a certain wavelength, polymerization reaction or decomposition reaction takes place. The photosensitive resin composition includes a negative type that becomes insoluble to chemicals when it is exposed to light, and a positive type that becomes soluble to chemicals when it is exposed to light. Either of them may be used. In this exemplary embodiment, the photosensitive layer 201 and the contact hole 182 are formed by using a negative photosensitive resin composition.

The photosensitive resin composition layer 202 may have a sufficient thickness so that the depressed portion of the color filter layer 181 can be filled with it.

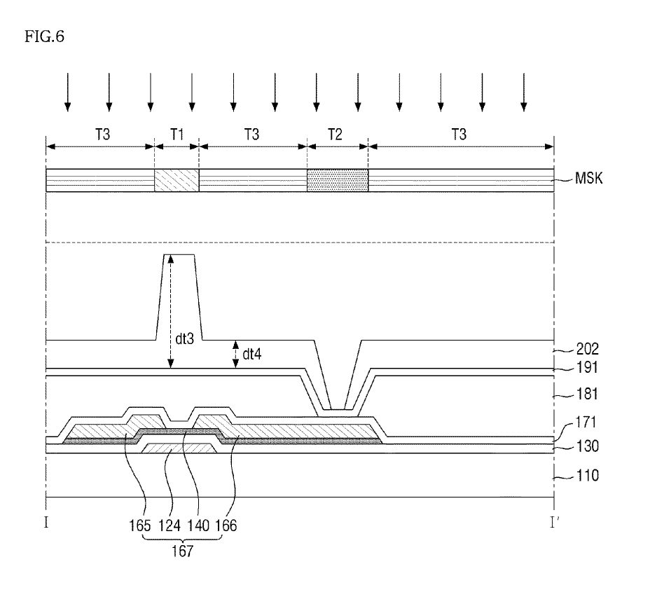

Subsequently, as shown in FIG. 6, the photosensitive resin composition layer 202 is exposed to light by using a halftone mask MSK or a slit mask, and the exposed photosensitive resin composition layer 202 is developed, to remove a part of it.

Specifically, a first transmission portion T1 of the halftone mask MSK is in line with the first area AR1, a second transmission portion T2 of the halftone mask MSK is in line with the second area AR2, and a third transmission portion T3 of the halftone mask MSK is in line with the third area AR3.

The first transmission portion T1 may transmit more light than the third transmission portion T3 does. The third transmission portion T3 may transmit more light than the second transmission portion T2 does. Accordingly, when the same amount of light is irradiated from above throughout the entire surface of the halftone mask MSK, the light may pass through the halftone mask MSK most in the first area AR1 and least in the second area AR2.

In this exemplary embodiment, the first transmission portion T1 of the halftone mask MSK is completely opened so that all of the light is transmitted, the second transmission portion T2 completely blocks the light, and the third transmission portion T3 is partially opened so that it blocks some of the light. It is to be noted that this is merely illustrative. The light transmittance of each of the first to third transmission portions T1, T2 and T3 may be adjusted individually.

After the exposure has been carried out with the halftone mask MSK, development is carried out to remove the rest of the photosensitive resin composition layer 202, leaving the cured portions. The portion of the photosensitive resin composition layer 202 formed in the first area AR1 where the light is irradiated most has a third thickness dt3, the portion of the photosensitive resin composition layer 202 formed in the second area AR2 where the light is irradiated least is opened, and the portion of the photosensitive resin composition layer 202 formed in the third area AR3 where the light is irradiated less than the first area AR1 and more than the second area AR2 has a fourth thickness dt4. The third thickness dt3 is larger than the fourth thickness dt4.

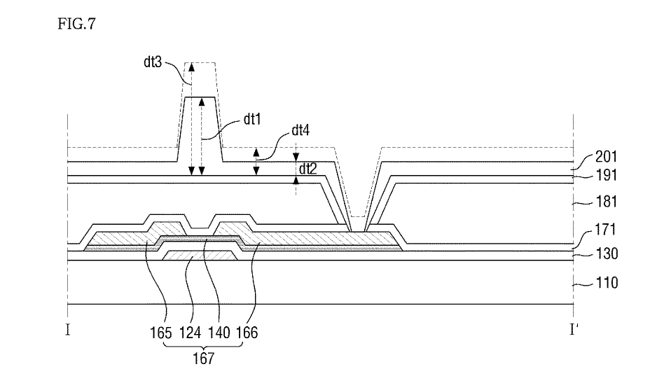

Subsequently, as shown in FIG. 7, an etch process is carried out to remove a part of the second passivation layer 191 exposed via the opened portion of the photosensitive resin composition layer 202. As the etch process is carried out, a part of the drain electrode 166 is exposed to form the contact hole 182.

In addition, as the etch process is carried out, the photosensitive resin composition layer 202 is also removed partially, forming the photosensitive layer 201. The photosensitive layer 201 may reflect the level differences of the photosensitive resin composition layer 202 before the etching. Accordingly, the photosensitive layer 201 may have a first thickness dt1 in the first area AR1 and a second thickness dt2 in the third area AR3, and the first thickness dt1 is larger than the second thickness dt2, as described above.

In this regard, the photosensitive layer 201 having the first thickness dt1 in the first area AR1 and the contact hole 182 are simultaneously formed in the same mask process. Therefore, the manufacturing cost of the LCD device can be saved, compared to a LCD that requires a process of forming an additional element for spacing the first display substrate 100 from the second display substrate 400.

As shown in FIGS. 2, 5 to 7, after the photosensitive layer 201 and the contact hole 182 have been formed, a pixel electrode 211 is formed via the seventh mask process.

Through the above-described processes, the first display substrate 100 of an LCD device according to the exemplary embodiment of the present disclosure may be manufactured, as shown in FIG. 2.

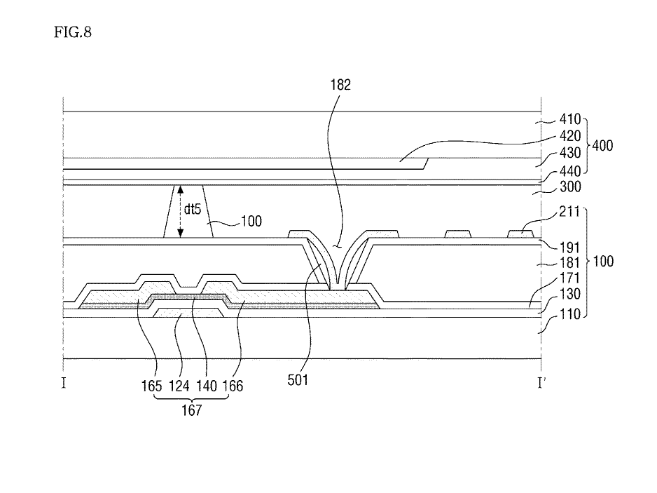

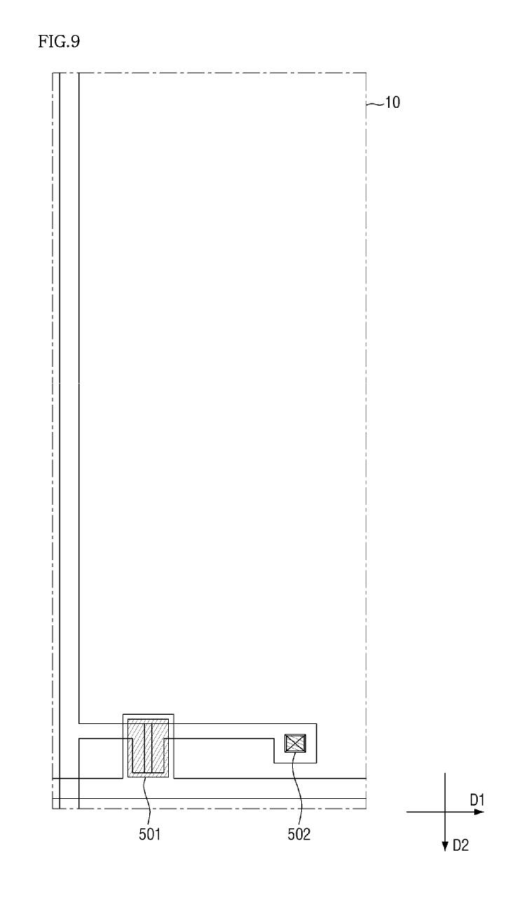

FIG. 8 is a cross-sectional view of a pixel of an LCD device according to another exemplary embodiment of the present disclosure, taken along line I-I′ of FIG. 1. FIG. 9 is a plan view showing an example layout of a data line, a gate line, a thin-film transistor, a contact hole and first and second photosensitive composition patterns in the pixel of the LCD device shown in FIG. 8.

In the following description, the same or similar elements will be denoted by the same or similar reference numerals, and redundant descriptions will be omitted or briefly described. Descriptions will be made focusing on differences from the above embodiment.

Referring to FIGS. 8 to 9, a first photosensitive composition pattern 501 and the second photosensitive composition pattern 502 are disposed, instead of the photosensitive layer 201 of the LCD according to the exemplary embodiment shown in FIG. 2.

The first photosensitive composition pattern 501 may be disposed on a second passivation layer 191 and may be in contact with a second display substrate 400. That is, the first photosensitive composition pattern 501 may work as a spacer. Accordingly, the first display substrate 100 and the second display substrate 400 may be spaced apart from each other by a certain gap except the portion where they come in contact with each other by the first photosensitive composition pattern 501, and a liquid-crystal layer 300 may be disposed therebetween.

The first photosensitive composition pattern 501 may overlap the thin-film transistor 167, especially the gate electrode 124. As a result, the first photosensitive composition pattern 501 may overlap the first area AR1 shown in FIG. 3.

In addition, the first photosensitive composition pattern 501 may have a fifth thickness dt5. The fifth thickness dt5 may be smaller than the first thickness dt1 that is the thickness of the photosensitive layer 201 disposed in the first area AR1 of FIG. 2. The relationship between the thicknesses may contribute to the manufacturing processing of the first photosensitive composition pattern 501, which will be described below.

The second photosensitive composition pattern 502 is disposed on the second passivation layer 191 and covers a part of the side walls of the contact hole 182 penetrating the first passivation layer 171 and the color filter layer 181. Although the second photosensitive composition pattern 502 covers the entire area of the side walls of the contact hole 182 in the exemplary embodiment shown in FIG. 8, but this is merely illustrative. That is, the second photosensitive composition pattern 502 may cover only the left or right side wall of the contact hole 182 shown in FIG. 8. Further, the second photosensitive composition pattern 502 may cover only a middle portion of the side walls of the contact hole 182 shown in FIG. 8, or may cover only a lower end of the side walls thereof. The second photosensitive composition pattern 502 may have different shapes in different pixels 10. The exemplary shapes have been described above.

A pixel electrode 211, which is in contact with a drain electrode 166, may be disposed along the side walls of the contact hole 182 and may be disposed on the second photosensitive composition pattern 502 such that it may reflect the surface level difference of the second photosensitive composition pattern 502.

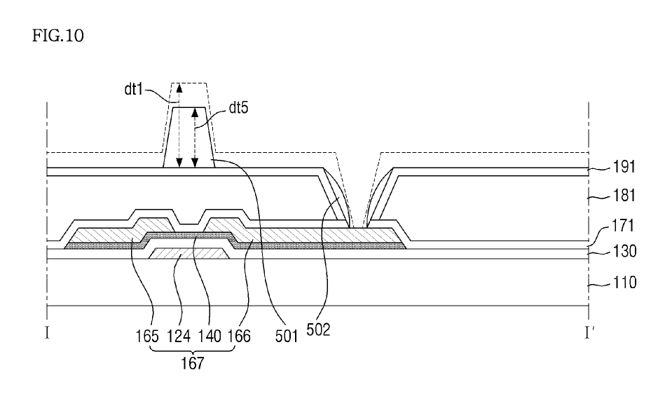

FIG. 10 shows a process operation of ashing to form the first photosensitive composition pattern 501 and the second photosensitive composition pattern 502.

Referring to FIG. 9, the first and second photosensitive composition patterns 501 and 502 according to the exemplary embodiment of the present disclosure are formed by additionally carrying out ashing on the photosensitive layer 201 formed via the processes shown in FIGS. 4 to 7.

The ashing is the process of removing the residual photosensitive resin composition after the etching is carried out. The ashing is carried out until the second passivation layer 191 is exposed except in the first area AR1 and the second area AR2. Accordingly, in the third area AR3 including the active area, there is no remaining photosensitive resin composition, and thus a higher transmittance can be achieved. In addition, the contact hole 182 and the first photosensitive composition pattern 501 are formed via a single mask process even by such processes, and thus the manufacturing cost of the LCD device can be saved, compared to an LCD that requires a process of forming an element for performing the same function with the first photosensitive composition pattern 501.

The features of the inventive concept are not limited by the foregoing, and other various features are anticipated herein.

In concluding the detailed description, those skilled in the art will appreciate that many variations and modifications can be made to the embodiments without substantially departing from the principles of the inventive concept. Therefore, the disclosed embodiments are used in a generic and descriptive sense only and not for purposes of limitation.

What is claimed is:

1. A liquid-crystal display (LCD) device comprising:
a first substrate;
a thin-film transistor disposed on the first substrate;
a color filter layer disposed on the thin-film transistor;
a photosensitive layer disposed on the color filter layer; and
a pixel electrode disposed on the photosensitive layer and connected to the thin-film transistor via a contact hole penetrating the photosensitive layer,
wherein the photosensitive layer comprises a first area overlapping the thin-film transistor, a second area overlapping the contact hole, and a third area that is the rest of the photosensitive layer except the first and second areas, and
wherein the photosensitive layer has a first thickness in the first area, is opened in a center of the second area, and has a second thickness in the third area, wherein the second thickness is smaller than the first thickness.

2. The LCD device of claim 1, wherein a side wall of the contact hole is covered by the photosensitive layer.

3. The LCD device of claim 2, wherein the photosensitive layer covering the side wall of the contact hole is covered by the pixel electrode.

4. The LCD device of claim 1, wherein the second thickness is half the first thickness or less.

5. The LCD device of claim 1, wherein the color filter layer comprises first, second, and third color filters,
wherein the first, second, and third color filters transmit light of different wavelength bands.

6. The LCD device of claim 1, further comprising:
a passivation layer disposed between the color filter layer and the photosensitive layer,
wherein the passivation layer overlaps the color filter layer except the area where the contact hole is disposed.

7. The LCD device of claim 1, further comprising:
a second substrate facing the first substrate,
wherein the photosensitive layer comes in contact with the second substrate in the first area.

8. The LCD device of claim 1, further comprising:
a gate line extended in a first direction on the first substrate; and
a data line extended in a second direction on the gate line, wherein the second direction intersects the first direction,
wherein the thin-film transistor comprises a gate electrode connected to the gate line, a source electrode connected to the data line, and a drain electrode connected to the pixel electrode.

9. The LCD device of claim 8, wherein the first area overlaps the gate electrode, and
wherein the contact hole overlaps an end of the drain electrode that is not adjacent to the source electrode.

10. A liquid-crystal display (LCD) device comprising:
a first substrate;
a thin-film transistor disposed on the first substrate;
a color filter layer disposed on the thin-film transistor;
first and second photosensitive composition patterns disposed on the color filter layer; and
a pixel electrode disposed on the second photosensitive composition pattern and connected to the thin-film transistor via a contact hole penetrating the color filter layer,
wherein a part of a side wall of the contact hole is covered by the second photosensitive composition pattern, and
wherein the first and second photosensitive composition patterns are made of a same material.

11. The LCD device of claim 10, wherein the first photosensitive composition pattern overlaps the thin-film transistor.

12. The LCD device of claim 10, wherein the second photosensitive composition pattern is covered by the pixel electrode.

13. The LCD device of claim 10, wherein the color filter layer comprises first, second, and third color filters,
wherein the first, second, and third color filters transmit light of different wavelength bands.

14. The LCD device of claim 10, further comprising:
a passivation layer disposed between the color filter layer and the first photosensitive composition pattern,
wherein the passivation layer overlaps the color filter layer except the area where the contact hole is disposed.

15. The LCD device of claim 10, further comprising:
a gate line extended in a first direction on the first substrate; and
a data line extended in a second direction on the gate line, wherein the second direction intersects the first direction,
wherein the thin-film transistor comprises a gate electrode connected to the gate line, a source electrode connected to the data line, and a drain electrode connected to the pixel electrode.

16. The LCD device of claim 15, wherein the first photosensitive composition pattern overlaps the gate electrode.

17. The LCD device of claim 16, wherein the contact hole overlaps an end of the drain electrode that is not adjacent to the source electrode.

18. A method of manufacturing a liquid-crystal display (LCD) device, the method comprising:
forming a thin-film transistor on a substrate;
forming an organic layer disposed on the thin-film transistor;
forming a photosensitive layer on the organic layer; and
forming a pixel electrode on the photosensitive layer,
wherein the forming the photosensitive layer comprises
(a) forming a photosensitive composition layer by applying a photosensitive composition on the organic layer,
(b) performing exposure and development so that the photosensitive composition layer has different thicknesses in different areas, and
(c) etching the photosensitive composition layer to expose an output terminal of the thin-film transistor.

19. The method of claim 18, wherein the (b) performing comprises performing exposure on the photosensitive composition layer by using a halftone mask having different light transmittances in the different areas,
wherein the halftone mask has a first transmittance in an area overlapping the thin-film transistor, a second transmittance in an area overlapping a contact hole connecting the thin-film transistor to the pixel electrode, and a third transmittance in another area, and
wherein the first transmittance is higher than the third transmittance, and the second transmittance is lower than the third transmittance.

20. The method of claim 18, wherein the forming the photosensitive layer further comprises (d) partially removing a residual of the photosensitive composition layer.
